(19) United States
(12) Patent Application Publication
(10) Pub. No.: US 2016/0141723 A1
(43) Pub. Date: May 19, 2016

(54) Electrolytes and Metal Hydride Batteries

(71) Applicant: BASF Corporation, Florham Park, NJ (US)

(72) Inventors: Jean Nei, Southgate, MI (US); Kwo Young, Troy, MI (US); Damian Rotarov, Ann Arbor, MI (US)

(21) Appl. No.: 14/540,191

(22) Filed: Nov. 13, 2014

(51) Int. Cl. H01M 10/26; H01M 4/24; H01M 4/38

(52) U.S. Cl. CPC H01M 10/26; H01M 4/381; H01M 4/242; H01M 2300/0014; H01M 2300/0091

(57) ABSTRACT

Metal hydride batteries comprising an electrolyte composition which comprises an aqueous solution comprising one or more compounds selected from the group consisting of metal hydroxides, metal oxide/hydroxides and ammonium hydroxides where when the electrolyte composition comprises KOH, the composition also comprises a further compound selected from the group consisting of metal hydroxides, metal oxide/hydroxides and ammonium hydroxides, exhibit reduced degradation of the anode material during operation. Anode materials advantageously exhibit ≦95% of the degradation of the same anode material in the same battery when replacing the electrolyte composition with 6 M aqueous KOH and exhibit conductivity of ≧50% of that of 6 M aqueous KOH. Anode materials are for example ABx high capacity hydrogen storage alloys comprising Mg where x is from about 0.5 to about 5 and which has a discharge capacity of ≧400 mAh/g.

### GOVERNMENT SUPPORT STATEMENT

This invention was made with government support under DE-AR0000386 awarded by Advanced Research Projects Agency-Energy under the Robust Affordable Next Generation EV Storage Program (RANGE). The government has certain rights in the invention.

The present invention is aimed at metal hydride (MH) batteries containing certain electrolyte compositions.

### BACKGROUND

Much progress has been made in optimizing the electrochemical performance and cycle life of metal hydride batteries through optimization of the electrodes. The electrolyte of metal hydride batteries is presently 30% by weight aqueous KOH. The aqueous KOH electrolyte is corrosive to many anode materials. The present invention is focused on improved electrolytes for metal hydride batteries.

### SUMMARY

Disclosed is a metal hydride battery (cell) comprising at least one negative electrode comprising an active anode material, at least one positive electrode comprising an active cathode material, a casing having said electrodes positioned therein and an electrolyte composition, where

the electrolyte composition comprises an aqueous solution comprising one or more compounds selected from the group consisting metal hydroxides, metal oxide/hydroxides and ammonium hydroxides,

the degradation of the anode material in the battery is ≦95% of the degradation of the same anode material in the same battery when replacing the electrolyte composition with 6 M aqueous KOH,

the conductivity of the electrolyte composition is ≧50% of 6 M aqueous KOH and where

when the electrolyte composition comprises KOH, the composition also comprises one or more further compounds selected from the group consisting of metal hydroxides, metal oxide/hydroxides and ammonium hydroxides.

Also disclosed is a metal hydride battery comprising at least one negative electrode comprising an active anode material, at least one positive electrode comprising an active cathode material, a casing having said electrodes positioned therein and an electrolyte composition, where

the anode material comprises Mg,

the electrolyte composition comprises an aqueous solution comprising one or more compounds selected from the group consisting of metal hydroxides, metal oxide/hydroxides and ammonium hydroxides and where

when the electrolyte composition comprises KOH, the composition also comprises one or more further compounds selected from the group consisting of metal hydroxides, metal oxide/hydroxides and ammonium hydroxides.

### DETAILED DISCLOSURE

The electrolyte composition is useful in a metal hydride battery (metal hydride cell). A metal hydride battery comprises at least one negative electrode, at least one positive electrode, a casing having said electrodes positioned therein and an electrolyte composition in contact with the electrodes.

The active material of the negative electrode (anode material) comprises an ABₓ type alloy capable of storing hydrogen where x is from about 0.5 to about 5. A is a hydride forming element and B is a weak or non-hydride forming element. The alloys are capable of reversibly absorbing and desorbing hydrogen.

The ABx type alloys are for example of the categories (with simple examples): AB (HfNi, TiFe, TiNi), AB₂ (Mn₂Zr, TiFe₂), A₂B (Hf₂Fe, Mg₂Ni), AB₃ (NdCo₃, GdFe₃), A₂B₇ (Pr₂, Ni₇, Ce₂Co₇) and AB₅ (LaNi₅, CeNi₅).

For example, the anode active material comprises Zr, Mn, V, Fe and Ni; Zr, Mn, V, Co and Ni; Ti, V and Ni; La and Ni; Ti, Zr, Ni, Cr and one or more elements selected from the group consisting of Al, Si, V, Mn, Fe, Co, Cu, Nb, Ag and Pd; Zr, Mo and Ni; or a lanthanide metal and at least one metals selected from Ni and Co.

The anode material may comprise a disordered multi-component material comprising one or more host elements selected from the group consisting of V, Zr, Nb, La, Si, Ca, Sc, Mg, Ti and Y and one or more modifier elements selected from the group consisting of Cu, Mn, C, Fe, Ni, Al, Co, Mo, W, Ti, Li and Re. The host elements are in general hydride formers. For instance, the host matrix is one or more of Ti, Mg and V and the modifier includes one or more of Ni, Cu, Fe and Al. Such disordered materials are taught in U.S. Pat. No. 4,623,597.

The anode material may comprise a multi-component, multi-phase alloy comprising V, Ti, Zr and Ni or V, Ti, Zr, Ni and Cr and one or more modifying elements selected from the group consisting of Al, Mn, Mo, Cu, W, Fe and Co. Such multi-phase materials are taught in U.S. Pat. No. 5,096,667.

The anode material may comprise disordered material comprising (base alloy)ₐCo_{b}Mn_{c}Fe_{d}Snₑ where base alloy comprises from 0.1 to 60 atomic percent (at %) Ti, 0.1 to 40 at % Zr, 0 to 60 at % V, 0.1 to 57 at % Ni and 0 to 56 at % Cr; b is 0 to 7.5 at %, c is 13 to 17 at %, d is 0 to 3.5 at %, e is 0 to 1.5 at % where a, b, c, d and e equal 100 at %. Such alloys are disclosed in U.S. Pat. No. 5,536,591.

The anode active material is for instance a LaNi₅ type alloy, a modified LaNi₅ type alloy, a TiNi type alloy or a modified TiNi type alloy. For example, the anode active material comprises one or more elements selected from the group consisting of Ti, V and Zr and one or more elements selected from the group consisting of Ni, Cr, Co, Mn, Mo, Nb, Fe, Al, Mg, Cu, Sn, Ag, Zn and Pd; or the anode active material comprises one or more elements selected from the group consisting of Sc, Y, La, Ce, Pr, Nd, Sm and Mm and one or more elements selected from the group consisting of Ni, Cr, Co, Mn, Fe, Cu, Sn, Al, Si, B, Mo, V, Nb, Ta, Zn, Zr, Ti, Hf and W. Such alloys may further include one or more glass forming elements selected from the group consisting of Al, B, C, Si, P, S, Bi, In and Sb. Such materials advantageously are disordered, multi-component materials having a density of hydrogen storage sites of greater than 1.2 E23/cc or greater than 1.5 E23/cc. Such materials are disclosed in U.S. Pat. No. 5,840,440.

The anode material may comprise a modified Ti—V—Zr—Ni—Mn—Cr alloy comprising (base alloy)ₐCo_{b}Fe_{c}Al_{d}Snₑ, where base alloy comprises from 0.1 to 60 at % Ti, 0.1 to 40 at % Zr, 0 to 60 at % V, 0.1 to 57 at % Ni, 5 to 22 at % Mn and 0 to 56 at % Cr, b is 0.1 to 10 at %, c is 0 to 3.5 at %, d is 0.1 to 10 at %, e is 0.1 to 3 at %. Suitable materials are taught in U.S. Pat. No. 6,270,719.

Suitable anode materials may comprise AB₂ type alloys, such as a modified TiMn₂ alloy comprising 2 to 5 at % Zr, 26 to 33 at % Ti, 7 to 13 at % V, 8 to 20 at % Cr, 36 to 42 at % Mn and one or more of 1 to 6 at % Ni, 2 to 6 at % Fe and 0.1 to 2 at % Al. The alloys may further contain up to 1 at % Mm. For instance Zr_{3.63}Ti_{29.8}V_{8.82}Cr_{9.85}Mn_{39.5}Ni_{2.0}Fe_{5.0}Al_{1.0}Mm_{0.4}; Zr_{3.6}Ti_{29.0}V_{8.9}Cr_{10.1}Mn_{40.1} Ni_{2.0}Fe_{5.1}Al_{1.2}; Zr_{3.6}Ti_{28.3}V_{8.8}Cr_{10.0}Mn_{40.7}Ni_{1.9}Fe_{5.1}Al_{1.6} and Zr₁Ti₃₃V12.₅₄Cr₁₅Mn₃₆Fe_{2.25}Al_{0.21}. Such alloys are disclosed in U.S. Pat. No. 6,536,487.

Suitable anode materials may comprise alloys where A₅B₁₉ type structures are 40 at % or more of the alloy of formula LaₐR_{1-a-b}Mg_{b}Ni_{c-d-e} where 0≦a≦0.5 at %, 0.1≦b≦0.2 at %, 3.7≦c≦3.9 at %, 0.1≦d≦0.3 and 0≦d≦0.2. These alloys are taught for instance in U.S. Pat. No. 7,829,220.

The anode material may comprise hydrogen-absorbing alloy particles containing at least Ni and a rare earth. The particles may have a surface layer and an interior where the surface layer has a nickel content greater than that of the interior and nickel particles having a size of from 10 nm to 50 nm are present in the surface layer. The material may comprise an alloy Ln₁₋ₓMgₓNi_{a-b-c}Al_{b}Z_{c}, where Ln is one or more rare earth elements, Z is one or more of Zr, V, Bn, Ta, Cr, Mo, Mn, Fe, Co, Ga, Zn, Sn, In, Cu, Si, P and B, 0.05≦x≦0.3 at %, 2.8≦a≦3.9 at %, 0.05≦b≦0.25 at % and 0.01≦c≦0.25. These materials are taught for example in U.S. Pat. No. 8,053,114.

The anode material may comprise a crystalline structure having a multiple phases containing at least an A₂B₇ type structure and a A₅B₁₉ type structure and a surface layer having a nickel content greater than that of the bulk. The alloys may be of formula Ln₁₋ₓMgₓNi_{y-a-b}AlₐM_{b}, where Ln is one or more rare earths including Y, M is one or more of Co, Mn and Zn, where 0.1≦x≦0.2 at %, 3.5≦y≦3.9 at %, 0.1≦a≦0.3 at % and 0≦b≦0.2. Such materials are disclosed in U.S. Pat. No. 8,124,281.

The anode material may comprise a hydrogen storage alloy of formula Ln₁₋ₓMgₓ(Ni_{1-y}T_{y})_{z} where Ln is one or more of lanthanide elements, Ca, Sr, Sc, Y, Ti, Zr and Hf, T is one or more elements selected from V, Nb, Ta, Cr, Mo, Mn, Fe, Co, Al, Ga, Zn, Sn, In, Cu, Si, P and B and where 0<x≦1 at %, 0≦y≦0.5 at %, and 2.5≦z≦4.5 at %. Suitable alloys are taught in U.S. Pat. No. 8,257,862.

The anode material may comprise La, Nd, Mg, Ni and Al; La, Nd, Mg, Ni, Al and Co; La, Pr, Nd, Mg, Ni and Al or La, Ce, Pr, Nd, Ni, Al, Co and Mn as taught in U.S. Pat. No. 8,409,753. The alloys are prepared by mixing the elements, heating in a high frequency induction furnace under argon to melt and cooling to form ingots.

The anode material may comprise a multi-phase alloy comprising an AB₂ type main phase and a second phase. The material is modified with a modifier element. For instance, the alloy comprises Ti, Zr, B, Ni and a modifier. The modifier may be a light rare earth such as Y. The alloy may be of formula Ti_{A}Zr_{B-X}Y_{X}V_{c}Ni_{D}M_{E} where A, B, C and D are each greater than 0 and less than or equal to 50 at %, X is greater than 0 and less than or equal to 4 at %, M is one or more metals selected from Co, Cr, Sn, Al and Mn and E is from 0 to 30 at %. These materials are taught for example in U.S. Pub. No. 2013/0277607.

The anode material may comprise a modified A₂B₇ type hydrogen storage alloy. For instance an AₓB_{y} alloy where A includes at least one rare earth element and also includes Mg; B includes at least Ni and the atomic ratio X to Y is from 1:2 to 1:5, for instance 1:3 to 1:4. The alloy may be modified by one or more elements selected from the group consisting of B, Co, Cu, Fe, Cr and Mn. The atomic ratio of Ni to modifier(s) may be from 50:1 to 200:1. The rare earths include La, Ce, Nd, Pr and Mm. The atomic ratio of rare earths to Mg may be from 5:1 to 6:1. The B elements may further include Al where the atomic ratio of Ni to Al may be from 30:1 to 40:1. The surface of the alloy may comprise catalytic metallic regions supported in a porous oxide support matrix. The catalytic metallic regions may be Ni or Ni alloy.

The anode material may be an ABx high capacity hydrogen storage alloy where x is from about 0.5 to about 5 and which has a discharge capacity of ≧400 mAh/g, ≧425 mAh/g, ≧450 mAh/g or ≧475 mAh/g.

The anode material is for instance a high capacity MH alloy containing magnesium (Mg), for example an AB, AB₂ or A₂B type alloy containing Mg and Ni. For instance, present anode materials are MgNi, MgNi₂ or Mg₂Ni. Such Mg and Ni containing alloys may be modified by one or more elements selected from the group consisting of rare earth elements and transition metals. For instance, the anode materials containing Mg and Ni may be modified by one or more elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca.

For instance, suitable anode materials comprise Mg and Ni and optionally one or more elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca.

Mm is “mischmetal”. Mischmetal is a mixture of rare earth elements. For instance, Mm is a mixture containing La, Nd and Pr, for instance containing Ce, La, Nd and Pr.

Magnesium-containing MH alloys are particularly susceptible to corrosion in a 30 weight percent (wt %) KOH electrolyte.

For example, suitable MH alloys include MgNi, Mg_{0.8}Ti_{0.2}Ni, Mg_{0.7}Ti_{0.3}Ni, Mg_{0.9}Ti_{0.1}Ni, Mg_{0.8}Zr_{0.2}Ni, Mg_{0.7}Ti_{0.225}La_{0.075}Ni, Mg_{0.8}Al_{0.2}Ni, Mg_{0.9}Ti_{0.1}Ni, Mg_{0.9}Ti_{0.1}NiAl_{0.05}, Mg_{0.08}Pd_{0.2}Ni, Mg_{0.09}Ti_{0.1}NiAl_{0.05}, Mg_{0.09}Ti_{0.1}NiAl_{0.05}Pd_{0.1}, Mg₅₀Ni₄₅Pd₅, Mg_{0.85}Ti_{0.15}Ni_{1.0} Mg_{0.95Ti0.15}Ni_{0.9}, Mg₂Ni, Mg_{2.0}Ni_{0.6}Co_{0.4}, Mg₂Ni_{0.6}Mn_{0.4}, Mg₂Ni_{0.7}Cu_{0.3}, Mg_{0.8}La_{0.2}Ni, Mg_{2.0}Co_{0.1}Ni, Mg_{2.1}Cr_{0.1}Ni, Mg_{2.0}Nb_{0.1}Ni, Mg_{2.0}Ti_{0.1}Ni, Mg₂.0V_{0.1}Ni, Mg_{1.3}Al_{0.7}Ni, Mg_{1.5}Ti_{0.5}Ni, Mg_{1.5}Ti_{0.3}Zr_{0.1}Al_{0.1}Ni, Mg_{1.75}Al_{0.25}Ni and (MgAl)₂Ni, Mg_{1.70}Al_{0.3}Ni.

For example, present anode materials are alloys of Mg and Ni in an atomic ratio of from about 1:2 to about 2:1 which may be modified by one or more elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca. The modifying element or elements may be present from about 0.1 to about 30 atomic percent (at %) or from about 0.25 to about 15 at % or from about 0.5, about 1, about 2, about 3, about 4 or about 5 at % to about 15 at %, based on the total alloy. The atomic ratio of Mg to Ni is for instance about 1:1. Thus, Mg and Ni together may be present from about 70 at % to about 99.9 at % based on the total alloy in modified alloys. Mg—Ni alloys may be unmodified where Mg and Ni together are present at 100 at %.

Suitable anode materials comprise Mg and Ni in an atomic ratio of from about 1:2 to about 2:1 where Mg and Ni together are present at a level of ≧70 at %, based on the total alloy.

Suitable anode materials are for example alloys that comprise ≧20 at % Mg.

Suitable anode materials may comprise Mg and Ni in an atomic ratio of from about 1:2 to about 2:1 and further comprise Co and/or Mn. Suitable anode materials are for instance Mg₅₂Ni₃₉Co₆Mn₃ and Mg₅₂Ni₃₉Co₃Mn₆.

Suitable high capacity anode materials are disclosed for example in U.S. Pat. Nos. 5,616,432 and 5,506,069.

The alloys may be formed via melt spinning rapid solidification and/or mechanical alloying. Other methods include RF sputtering, laser ablation.

The active materials of the positive electrode (cathode materials) participate in the charge/discharge reactions. The active materials are for instance nickel hydroxide active materials, i.e. nickel hydroxide or modified nickel hydroxide.

The cathode materials may comprise a multi-phase disordered nickel hydroxide material having at least one modifier. The at least one modifier is for instance a metal, a metallic oxide, a metallic oxide alloy, a metal hydride and/or a metal hydride alloy. For example, the modifier is one or more components selected from the group consisting of Al, Ba, Ca, F, K, Li, Mg, Na, Sr, Bi, Co, Cr, Cu, Fe, In, LaH₃, Mn, Ru, Sb, Sn, TiH₂, TiO, and Zn. Such materials are taught in U.S. Pat. No. 5,348,822.

Suitable cathode materials may comprise a disordered multi-phase nickel hydroxide matrix including at least one modifier, for example 3 modifiers, chosen from F, Li, Na, K, Mg, Ba, Ln, Se, Nd, Pr, Y, Co, Zn, Al, Cr, Mn, Fe, Cu, Zn, Sc, Sn, Sb, Te, Bi, Ru and Pb. Suitable cathode materials are taught for example in U.S. Pat. No. 5,637,423.

Cathode materials may comprise nickel hydroxide modified with one or more group II elements and Co in a solid solution state. Such materials are taught in U.S. Pat. No. 5,366,831.

The cathode active materials may comprise nickel hydroxide and one or more components selected from the group consisting of cobalt, cobalt hydroxide and cobalt oxide and a carbon powder. The cathode materials may further comprise a compound of Ca, Sr, Ba, Cu, Ag or Y, for example Ca(OH)₂, CaO, CaF₂, CaS, CaSO₄, CaSi₂O₅, CaC₂O₄, CaWO₄, SrCO₃, Sr(OH)₂, BaO, Cu₂O, Ag₂O, Y₂(CO₃)₃ or Y₂O₃. Suitable cathode materials are taught for instance in U.S. Pat. No. 5,451,475.

Cathode active materials may comprise a metal oxide and one or more of Co, Ca, Ag, Mn, Zn, V, Sb, Cd, Y, Sr, Ba and oxides of Ca, Sr, Ba, Sb, Y or Zn. The metal oxide is for example nickel oxide and or manganese oxide. Such active materials are taught in U.S. Pat. No. 5,455,125.

The cathode materials may contain nickel hydroxide and a further component selected from the group consisting of Y, In, Sb, Ba and Be and Co and/or Ca. Such materials are disclosed in U.S. Pat. No. 5,466,543.

Cathode materials may be prepared by reacting nickel sulfate and ammonium hydroxide to form a nickel ammonium complex; the complex is then reacted with sodium hydroxide to form nickel hydroxide. The method may provide nickel hydroxide comprising one or more of Co, Zn and Cd. These materials are taught for instance in U.S. Pat. No. 5,498,403.

Cathode active materials may comprise nickel hydroxide and cobalt oxyhydroxide as taught in U.S. Pat. No. 5,489,314.

Cathode materials may comprise nickel hydroxide, cobalt monoxide and elemental zinc as taught in U.S. Pat. No. 5,506,070.

The cathode materials may comprise nickel hydroxide, nickel powder, a second powder and at least one of cobalt, cobalt hydroxide and cobalt oxide. The second powder contains one or more of Ca, Sr, Ba, Cu, Ag and Y. Such materials are taught in U.S. Pat. No. 5,571,636.

The cathode active materials may comprise particles of nickel hydroxide or manganese hydroxide having at least partially embedded therein a conductive material. The conductive material may be for instance nickel, nickel alloys, copper, copper alloys; metal oxides, nitrides, carbides, silicides or borides; or carbon (graphite). These materials are disclosed for example in U.S. Pat. No. 6,177,213.

The cathode materials may comprise nickel hydroxide particles containing at least three modifiers selected from the group consisting of Al, Bi, Ca, Co, Cr, Cu, Fe, In, La, rare earths, Mg, Mn, Ru, Sb, Sn, Ti, Ba, Si, Sr and Zn. For example, nickel hydroxide particles may contain at least four modifiers, for instance, Ca, Co, Mg and Zn. Such materials are disclosed in U.S. Pat. No. 6,228,535.

The positive electrode for instance comprises nickel hydroxide and a carbon material such as graphite. The positive electrode may also comprise a polymeric binder. The polymeric binder is for example a thermoplastic organic polymer, for instance selected from the group consisting of polyvinyl alcohol (PVA), polyethylene oxide, polypropylene oxide, polybutylene oxide, methyl cellulose, carboxymethyl cellulose, hydroxyethyl cellulose, hydroxypropyl cellulose, hydroxypropylmethyl cellulose, polyethylene, polypropylene, polyisobutylene, polyvinyl chloride, polyvinyliden chloride, polyvinyliden fluoride, polytetrafluoroethylene (PTFE), fluorinated ethylene propylene (FEP), perfluroalkoxy (PFA), polyvinylacetate, polyvinyl isobutylether, polyacrylonitrile, polymethacrylonitrile, polymethylmethacrylate, polymethylacrylate, polyethyl methacrylate, allyl acetate, polystyrene, polybutadiene, polyisoprene, polyoxymethylene, polyoxyethylene, polycyclic thioether, polydimethylsiloxane, polyesters such as polyethylene terephthalate, polycarbonate and polyamide. Blends and copolymers of the above are also suitable. The polymeric binder may also be an elastomer or rubber such as styrene-butadiene copolymer, styrene-butadiene-styrene block copolymer, styrene-isoprene block copolymer, styrene-isoprene-styrene block copolymer, styrene-ethylene-styrene-butadiene block copolymer, styrene-ethylene-butadiene-styrene block copolymer or styrene-acrylonitrile-butadiene-methyl acrylate copolymer. Suitable active materials are taught for instance in U.S. Pat. No. 6,617,072.

The cathode active material may contain nickel hydroxide and nickel oxyhydroxide as taught in U.S. Pat. No. 7,396,379.

Generally, cathode active material particles are formed in a sintered or pasted electrode. The pasted electrode may be made by mixing the material with various additives and/or binders and applying the paste to a conductive support. Preferably, one or more cobalt additives are added to the pasted electrode. The cobalt additives may include Co and/or CoO to enhance conductivity, improve utilization and reduce electrical resistance of the positive electrode.

In general, cathode active materials are nickel hydroxide or modified nickel hydroxide. Modified nickel hydroxide may contain one or more modifiers such as Co, Cd, Ag, V, Sb, Ca, Mg, Al, Bi, Cr, Cu, Fe, In, rare earths, Mn, Ru, Sn, Ti, Ba, Si, Sr or Zn. A suitable modified nickel hydroxide is (Ni,Co,Zn)(OH)₂, for instance in the form of a spherical powder. In modified nickel hydroxides, nickel generally is present at a level of ≧80 atomic percent, for instance ≧90 atomic percent, based on the metals.

For example, the MH battery comprises at least one negative electrode which comprises an ABₓ type alloy capable of reversibly storing hydrogen and comprises as least one positive electrode comprising nickel hydroxide or modified nickel hydroxide active materials.

A separator may be present which separates the negative electrodes from the positive electrodes. The separator is for instance a nonwoven web of natural or synthetic fibers. Natural fibers include cotton. Synthetic fibers include polyamide, polyester, polypropylene (PP), polyethylene (PE), PP/PE copolymer, polytetrafluoroethlene (PTFE), polyvinylchloride and glass.

The electrolyte composition comprises an aqueous solution comprising one or more compounds selected from the group consisting of metal hydroxides, metal oxide/hydroxides and ammonium hydroxides.

The metal hydroxides and oxide/hydroxides contain metals selected from the group consisting of transition metals, rare earth metals, alkali earth metals, alkali metals, post-transition metals and metalloid metals.

Transition metals include Ti, V, Cr, Mn, Fe, Co, Ni, Cu, Zn, Zr, Hf, W, Au, Ag and Pt.

Rare earth metals include Sc, Y, La and the lanthanides.

Alkali earth metals include Be, Mg, Ca, Ba and Sr.

Alkali metals include Na, K, Rb, Cs and Li.

Post-transition metals include Al, Ga, In, Bi, Pb and Sn.

Metalloid metals include Ge, As, Sb and Te.

Examples include titanium hydroxide, nickel hydroxide, yttrium hydroxide, calcium hydroxide, sodium hydroxide, aluminum hydroxide and antimony hydroxide.

Examples also include beryllium hydroxide, aluminum hydroxide, scandium hydroxide, vanadium hydroxide, chromium hydroxide, iron hydroxide, cobalt hydroxide, copper hydroxide, zinc hydroxide, gallium hydroxide, germanium hydroxide, arsenic hydroxide, zirconium hydroxide, silver hydroxide, indium hydroxide, tin hydroxide, gold hydroxide, lead hydroxide and bismuth hydroxide.

Many present metal hydroxides and metal oxide/hydroxides are advantageously employed together in an aqueous solution of a strong base such as KOH or NaOH.

If the electrolyte composition comprises KOH, then the composition comprises one or more further compounds selected from the group consisting of metal hydroxides, metal oxide/hydroxides and ammonium hydroxides.

Metal oxide-hydroxides include AlO(OH), NiO(OH) and FeO(OH).

Ammonium ions are cations of formula ⁺NR₁R₂R₃R₄ where R₁, R₂, R₃ and R₄ are selected from hydrogen and hydrocarbyl or two of R₁-R₄ together are hydrocarbylene or three of R₁-R₄ together are hydrocarbylene. When one or more of R₁-R₄ is hydrogen, the ammonium ion is protic. When all four of R₁-R₄ are hydrocarbyl or hydrocarbylene the ammonium ion is aprotic.

Ammonium ions also include hydrazinium cations of formula R₁R₂N—⁺NR₃R₄R₅, where R₁, R₂, R₃, R₄ and R₅ are selected from hydrogen and hydrocarbyl or R₁ and R₂ together and/or two of R₃-R₅ together are hydrocarbylene.

Ammonium ions also include hydroxylammonium cations of formula HO—N⁺R₁R₂R₃ where R₁, R₂ and R₃ are selected from hydrogen and hydrocarbyl or two of R₁-R₃ together are hydrocarbylene.

Hydrocarbyl is any hydrocarbon based group, bound to the cationic nitrogen with a carbon atom. Hydrocarbylene is a ring-forming version of hydrocarbyl.

Hydrocarbyl is for instance alkyl, alkenyl, cycloalkyl, cycloalkenyl, aryl or aralkyl, which may be substituted by one or more groups selected from the group consisting of halogen, hydroxy, C₁-C₄alkoxy, thio, C₁-C₄alkylthio, amino, C₁-C₄alkylamino, di-C₁-C₄alkylamino, nitro, cyano, —COOH and —COO⁻. Hydrocarbyl may also be interrupted by one or more groups selected from the group consisting of —O—, —S—, —NH— and —N(C₁-C₄alkyl)-. Hydrocarbyl may be both substituted by one or more of said groups and interrupted by one or more of said groups. For instance alkyl, alkenyl, cycloalkyl, cycloalkenyl, aryl or aralkyl may be substituted by one to three groups selected from the group consisting of chloro, hydroxy, methoxy, ethoxy, propoxy, butoxy, thio, methylthio, methylamino, ethylamino, propylamino, butylamino, dimethylamino, diethylamino, dipropylamino, dibutylamino, —COOH, —COO⁻, cyano and nitro and/or may be interrupted by one to three groups selected from the group consisting of —O—, —S—, —NH— and —N(C₁-C₄alkyl)-.

Hydrocarbyl also includes polyethylene glycols and polypropylene glycols such as R′(OC₂H₄)ₙ— or R′(OC₃H₆)ₙ— where R′ is hydrogen or alkyl and n is an integer from 1 to 50, for instance from 1 to 40, 1 to 30 or 1 to 20, for instance from 1 to 10.

When two or three of R₁-R₅ together are hydrocarbylene, this means together with the N atom they form a heterocyclic ring. The ring is for example 5- or 6-membered. The heterocyclic ring may contain a further heteroatom and may be saturated or unsaturated. Hydrocarbylene is for instance —(CH₂)₄—, —(CH₂)₅—, —(CH₃)N—CH═C(CH₃)—CH═, ═CH—CH═CH—CH═CH—, ═C(CH₃)—C═CH—CH═CH—, ═C—C(CH₃)═CH—CH═CH—, ═C—CH═C(CH₃)—CH═CH—, —CH═CH—CH═CH—, —CH₂═CH—CH₂—CH₂—, —CH═CH—N═CH—, —CH₂CH₂NHCH₂CH₂—, —CH₂—CH₂—N═CH—, —CH₂—CH₂—O—CH₂—CH₂— or ═CH—(CH₂)₃—. The further heteroatom is for example N, O or S.

Examples of ammonium ion rings are piperidinium, pyrrolinium, 2,4-dimethylpyrazolium, pyrrolininium, pyrrolidinium, pyridinium, morpholinium and methylpyridinium. Pyridinium is an example of where three of R₁-R₄ together form a ring. The hydrocarbylene ring may also be annulated to form for instance quinolinium or isoquinolinium.

Alkyl is for instance from 1 to 25 carbon atoms, is branched or unbranched and includes methyl, ethyl, propyl, isopropyl, n-butyl, sec-butyl, isobutyl, tert-butyl, 2-ethylbutyl, n-pentyl, isopentyl, 1-methylpentyl, 1,3-dimethylbutyl, n-hexyl, 1-methylhexyl, n-heptyl, isoheptyl, 1,1,3,3-tetramethylbutyl, 1-methylheptyl, 3-methylheptyl, n-octyl, 2-ethylhexyl, 1,1,3-trimethylhexyl, 1,1,3,3-tetramethylpentyl, nonyl, decyl, undecyl, 1-methylundecyl, dodecyl, 1,1,3,3,5,5-hexamethylhexyl, tridecyl, tetradecyl, pentadecyl, hexadecyl, heptadecyl, octadecyl, icosyl and docosyl.

Alkenyl is an unsaturated version of alkyl, for instance allyl.

Cycloalkyl includes cyclopentyl, methylcyclopentyl, dimethylcyclopentyl, cyclohexyl, methylcyclohexyl, dimethylcyclohexyl, trimethylcyclohexyl, tert-butylcyclohexyl, cycloheptyl or cyclooctyl.

Cycloalkenyl is an unsaturated version of cycloalkyl.

Aryl includes phenyl, o-, m- or p-methylphenyl, 2,3-dimethylphenyl, 2,4-dimethylphenyl, 2,5-dimethylphenyl, 2,6-dimethylphenyl, 3,4-dimethylphenyl, 3,5-dimethylphenyl, 2-methyl-6-ethylphenyl, 4-tert-butylphenyl, 2-ethylphenyl or 2,6-diethylphenyl.

Aralkyl includes benzyl, α-methylbenzyl, α,α-dimethylbenzyl and 2-phenylethyl.

Examples of protic ammonium ions include NH₄⁺ (ammonium), methylammonium, ethylammonium, dimethylammonium, diethylammonium, trimethylammonium (NMe₃H⁺), triethylammonium, tributylammonium, diethylmethylammonium, hydroxyethylammonium, methoxymethylammonium, dibutylammonium, methylbutylammonium, anilinium, pyridinium, 2-methylpyridinium, imidazolium, 1-methylimidazolium, 1,2-dimethylimidazolium, imidazolinium, 1-ethylimidazolium, 1-(4-sulfobutyl)-3-methylimidazolium, 1-allylimidazolium, ethanolammonium, quinolinium, isoquinolinium, pyrrolinium, pyrrolininium and pyrrolidinium.

Examples of aprotic ammonium ions include tetramethylammonium, tetraethylammonium, tetra-n-butylammonium, n-butyl-tri-ethylammonium, benzyl-tri-methylammonium, tri-n-butylmethylammonium, benzyl-tri-ethylammonium, 1-methylpyridinium, 1-butyl-3,5-dimethylpyridinium, 1,2,4-trimethylpyrazolium, trimethylhydroxyethylammonium (choline), tri-(hydroxyethyl)methylammonium, dimethyl-di(polyoxyethylene)ammonium, 1,2,3-trimethylimidazolium, 1-butyl-3-methylimidazolium, 1-ethyl-2,3-dimethylimidazolium, 1-allyl-3-methylimidazolium, 1-hydroxyethyl-3-methylimidazolium, 1,3-dimethylimidazolium, 1-ethyl-1-methylpiperidinium, 4-ethyl-4-methylmorpholinium, 1-(cyanomethyl)-3-methylimidazolium, 1-(3-cyanopropyl)pyridinium, 1,3-bis(cyanomethyl)imidazolium and 1-ethyl-3-methylimidazolium.

Pyrrolinium is the ammonium of pyrrole, pyrrolininium is the ammonium of pyrroline and pyrrolidinium is the ammonium of pyrrolidine. Pyrroline may be 1-, 2- or 3-pyrroline, thus the ammonium cation of 1-, 2- or 3-pyrroline is included.

An example of a hydrazinium ion is hydrazinium (H₂NNH₃⁺).

An example of a hydroxylammonium ion is hydroxylammonium (HO—NH₃⁺).

The molar concentration of the one or more metal hydroxide, metal oxide/hydroxide or ammonium hydroxide compound or compounds in the aqueous solution in total may be from about 1 M (molar) to about 8 M, from about 2 M to about 7 M, from about 2 M to about 6 M or about 3 M, about 4 M or about 5 M. The molar concentration of individual compounds may be as low as about 0.25 M.

Advantageously, the electrolyte composition comprises one or more compounds selected from the group consisting of NaOH, CsOH, ammonium hydroxides and RbOH.

For instance, the aqueous solution may comprise NaOH at a concentration of from about 3 M to about 7 M, for example about 4 M, about 5 M or about 6 M. The aqueous solution may comprise both NaOH and KOH, each in a concentration of from about 0.5 M to about 6 M with a total concentration of from about 1 M to about 8 M. Suitable molar ratios of NaOH:KOH include about 5:1, about 4:1, about 3:1, about 4:2, about 3:2, about 1:2, about 1:3, about 1:5, about 1:10, about 1:11 and ratios in between. The total concentration of NaOH and KOH together is advantageously from about 2 M to about 7 M or from about 3 M to about 6 M.

The aqueous solution may comprise CsOH at a concentration of from about 2 M to about 6 M, for example, about 3 M, about 4 M or about 5 M. The aqueous solution may comprise both CsOH and KOH, each in a concentration of from about 0.5 M to about 6 M with a total concentration of from about 1 M to about 8 M. Suitable molar ratios of CsOH:KOH include about 5:1, about 4:1, about 3:1, about 2:1, about 1:1, about 3:2, about 1:2, about 1:3 and ratios in between. The total concentration of CsOH and KOH together is advantageously from about 2 M to about 7 M or from about 2 M to about 6 M.

The aqueous solution may comprise an ammonium hydroxide at a concentration of from about 0.3 M to about 5 M, for example about 0.6 M, about 1 M, about 2 M, about 3 M or about 4 M. The aqueous solution may comprise both an ammonium hydroxide compound and KOH, with the ammonium hydroxide in a concentration of from about 0.3 M to about 3 M and KOH in a concentration of from about 1 M to about 6 M with a total concentration of from about 1.3 M to about 8 M. Suitable molar ratios of ammonium hydroxide:KOH include about 1:2, about 1:3, about 1:4, about 1:5, about 1:6, about 1:7, about 1:8 and ratios in between.

The aqueous solution may comprise RbOH at a concentration of from about 2 M to about 6 M, for example about 3 M, about 4 M or about 5 M. The aqueous solution may comprise both RbOH and KOH, with RbOH in a concentration of from about 2 M to about 6 M and KOH in a concentration of from about 0.5 M to about 3 M with a total concentration of from about 2.5 M to about 8 M. Suitable molar ratios of RbOH:KOH include about 5:1, about 4:1, about 3:1, about 2:1 and about 3:2.

The degradation of the anode material in the battery is advantageously ≦90%, ≦85%, ≦80%, ≦75% or ≦70% of the degradation of the same anode material in the same battery when replacing the electrolyte composition with 6 M aqueous KOH.

The conductivity of the electrolyte composition is advantageously ≧55%, ≧60%, ≧65%≧70% or ≧75% of that of 6 M aqueous KOH.

Degradation is measured for instance via cycle stability of the anode material under operating conditions in a flooded cell. A typical battery cell may be prepared as described in the working Examples. The cell is charged at a current density of 100 mA/g for 5 hours and discharged at a current density of 100 mA/g until a cut-off voltage of 0.9 V is reached, discharged at a current density of 24 mA/g until a cut-off voltage of 0.9 V is reached and finally discharged at a current density of 8 mA/g until a cut-off voltage of 0.9 V is reached. The full discharge capacity is the sum of capacities measured at 100, 24 and 8 mA/g for each cycle.

Degradation is determined after a certain number of cycles, for instance after 5, 6, 7, 8, 9 or 10 cycles. Degradation is defined as percent capacity loss per cycle.

Percent capacity loss per cycle is:

$$\frac{{cap}_{high} - {cap}_{low}}{( {η}_{low} - {η}_{high} ) \cdot {cap}_{high}} \cdot 100 ,$$

where

cap_{high} is the highest value of discharge capacity,

cap_{low} is the lowest value of discharge capacity,

η_{high} is the cycle number of the highest discharge capacity and

η_{low} is the cycle number of the lowest discharge capacity.

The ratio of percent capacity loss per cycle when employing an anode material in a flooded cell with a present electrolyte composition to that in a flooded cell with 6 M KOH electrolyte, multiplied by 100, provides the relative degradation percent of the embodiments and claims.

For example, cap_{high} discharge capacity of an anode material is determined to be 400 mA/g after 1 cycle in a present electrolyte composition. After 10 cycles operation in a present electrolyte composition, cap_{low} is determined to be 350 mA/g. The percent capacity loss per cycle is (400−350)/(9·400)·100=1.39%.

When employing the same anode material in the same flooded cell, replacing the electrolyte composition with 6 M KOH, the discharge capacity is determined to be 400 mA/g after 1 cycle and 200 mA/g after 10 cycles. The percent capacity loss per cycle is (400-200)/(9·400)·100=5.56%.

In this example, the degradation of the anode material in the flooded cell with a present electrolyte composition is 25% of that of the same anode material in the same flooded cell but with 6 M KOH as the electrolyte ((1.39/5.56)·100).

Capacities are suitably measured with an Arbin Instruments Battery Test System or with a Maccor Instruments Battery Test System.

Conductivity is measured with any suitable conductivity device, for example a YSI model 3200 conductivity meter or a digital conductivity meter with a probe produced by TRACEABLE VWR Inc.

All measurements herein, for example degradation, conductivity and concentrations are determined at 25° C. and atmospheric pressure.

The terms “a” or “an” referring to elements of an embodiment may mean “one” or may mean “one or more”.

The term “about” refers to variation that can occur, for example, through typical measuring and handling procedures; through inadvertent error in these procedures; through differences in the manufacture, source, or purity of ingredients used; through differences in methods used; and the like. The term “about” also encompasses amounts that differ due to different equilibrium conditions for a composition resulting from a particular initial mixture. Whether or not modified by the term “about,” embodiments and claims include equivalents to the recited quantities.

All numeric values herein are modified by the term “about,” whether or not explicitly indicated. The term “about” generally refers to a range of numbers that one of skill in the art would consider equivalent to the recited value (i.e., having the same function and/or result). In many instances, the term “about” may include numbers that are rounded to the nearest significant figure.

A value modified by the term “about” of course includes the specific value. For instance, “about 5.0” must include 5.0.

The term “consisting essentially of” means that the composition, method or structure may include additional ingredients, steps and/or parts, but only if the additional ingredients, steps and/or parts do not materially alter the basic and novel characteristics of the claimed composition, method or structure.

U.S. patents, U.S. published patent applications and U.S. patent applications discussed herein are each hereby incorporated by reference.

Following are some embodiments of the invention.

E1. A metal hydride battery comprising at least one negative electrode comprising an active anode material, at least one positive electrode comprising an active cathode material, a casing having said electrodes positioned therein and an electrolyte composition, where

the anode material comprises Mg, for instance ≧20 at % Mg,

the electrolyte composition comprises an aqueous solution comprising one or more compounds selected from the group consisting of metal hydroxides, metal oxide/hydroxides and ammonium hydroxides and where

when the electrolyte composition comprises KOH, the composition also comprises one or more further compounds selected from the group consisting of metal hydroxides, metal oxide/hydroxides and ammonium hydroxides.

E2. A battery according to embodiment 1 where the anode material comprises an ABx hydrogen storage alloy where x is from about 0.5 to about 5 and which has a discharge capacity of ≧400 mAh/g, ≧425 mAh/g, ≧450 mAh/g or ≧475 mAh/g.
E3. A battery according to embodiments 1 or 2 where the anode material comprises Mg and Ni in an atomic ratio of from about 1:2 to about 2:1.
E4. A battery according to embodiment 3 where the anode material further comprises one or more modifying elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca.
E5. A battery according to embodiment 4 where the one or more modifying elements are present from about 0.1 to about 30 at % or from about 0.25 to about 15 at % or from about 0.5, about 1, about 2, about 3, about 4 or about 5 at % to about 15 at %, based on the total alloy.
E6. A battery according to any of embodiments 3 to 5 where the atomic ratio of Mg to Ni is about 1:1.
E7. A battery according to any of embodiments 1 to 5 where the anode material is Mg₅₂Ni₃₉Co₆Mn₃ or Mg₅₂Ni₃₉Co₃Mn₆.
E8. A battery according to any of the preceding embodiments where the electrolyte composition comprises one or more ammonium hydroxide compounds.
E9. A battery according to any of the preceding embodiments where the electrolyte composition comprises one or more metal hydroxides.
E10. A battery according to any of the preceding embodiments where the electrolyte composition comprises one or more metal oxide/hydroxides.
E11. A battery according to any of the preceding embodiments where the electrolyte composition comprises one or more transition metal hydroxides.
E12. A battery according to any of the preceding embodiments where the electrolyte composition comprises one or more rare earth metal hydroxides.
E13. A battery according to any of the preceding embodiments where the electrolyte composition comprises one or more alkali metal hydroxides.
E14. A battery according to any of the preceding embodiments where the electrolyte composition comprises one or more alkali earth metal hydroxides.
E15. A battery according to any of the preceding embodiments where the electrolyte composition comprises one or more post-transition metal hydroxides.
E16. A battery according to any of the preceding embodiments where the electrolyte composition comprises one or more metalloid metal hydroxides.
E17. A battery according to any of the preceding embodiments where the electrolyte composition comprises one or more compounds selected from the group consisting of LiOH, NaOH, KOH, RbOH, CsOH, Be(OH)₂, Mg(OH)₂, Ca(OH)₂, Sr(OH)₂, Ba(OH)₂ and ammonium hydroxide compounds.
E18. A battery according to any of the preceding embodiments where the electrolyte composition comprises one or more compounds selected from the group consisting of NaOH, RbOH, CsOH and ammonium hydroxide compounds.
E19. A battery according to any of the preceding embodiments where the electrolyte composition comprises one or more ammonium hydroxide compounds containing an ammonium cation selected from the group consisting of NH₄⁺ (ammonium), methylammonium, ethylammonium, dimethylammonium, diethylammonium, trimethylammonium (NMe₃H⁺), triethylammonium, tributylammonium, diethylmethylammonium, hydroxyethylammonium, methoxymethylammonium, dibutylammonium, methylbutylammonium, anilinium, pyridinium, 2-methylpyridinium, imidazolium, 1-methylimidazolium, 1,2-dimethylimidazolium, imidazolinium, 1-ethylimidazolium, 1-(4-sulfobutyl)-3-methylimidazolium, 1-allylimidazolium, ethanolammonium, quinolinium, isoquinolinium, pyrrolinium, pyrrolininium, pyrrolidinium, tetramethylammonium, tetraethylammonium, tetra-n-butylammonium, n-butyl-tri-ethylammonium, benzyl-tri-methylammonium, tri-n-butylmethylammonium, benzyl-tri-ethylammonium, 1-methylpyridinium, 1-butyl-3,5-dimethylpyridinium, 1,2,4-trimethylpyrazolium, trimethylhydroxyethylammonium (choline), tri-(hydroxyethyl)methylammonium, dimethyl-di(polyoxyethylene)ammonium, 1,2,3-trimethylimidazolium, 1-butyl-3-methylimidazolium, 1-ethyl-2,3-dimethylimidazolium, 1-allyl-3-methylimidazolium, 1-hydroxyethyl-3-methylimidazolium, 1,3-dimethylimidazolium, 1-ethyl-1-methylpiperidinium, 4-ethyl-4-methylmorpholinium, 1-(cyanomethyl)-3-methylimidazolium, 1-(3-cyanopropyl)pyridinium, 1,3-bis(cyanomethyl)imidazolium and 1-ethyl-3-methylimidazolium.
E20. A battery according to any of the preceding embodiments comprising at least two different compounds selected from the group consisting of metal hydroxides, metal oxide/hydroxides and ammonium hydroxides.
E21. A battery according to any of the preceding embodiments where the electrolyte composition comprises aqueous NaOH in a concentration of from about 3 M to about 7 M, or about 4 M, about 5 M or about 6 M.
E22. A battery according to any of the preceding embodiments where the electrolyte composition comprises aqueous CsOH in a concentration of from about 2 M to about 6 M, or about 3 M, about 4 M or about 5 M.
E23. A battery according to any of the preceding embodiments where the electrolyte composition comprises aqueous RbOH in a concentration of from about 2 M to about 6 M, or about 3 M, about 4 M or about 5 M.
E24. A battery according to any of the preceding embodiments where the electrolyte composition comprises one or more aqueous ammonium hydroxide compounds in a total concentration of from about 0.3 M to about 5 M, or about 0.6 M, about 1 M, about 2 M, about 3 M or about 4 M.
E25. A battery according to embodiment 20 where the electrolyte composition comprises an aqueous solution of NaOH and KOH, each in a concentration of from about 0.5 M to about 6 M with a total combined concentration of from about 1 M to about 8 M, from about 2 M to about 7 M or from about 3 M to about 6 M.
E26. A battery according to embodiment 25 where the molar ratio of NaOH to KOH is from about 5:1 to about 1:11.
E27. A battery according to embodiment 20 where the electrolyte composition comprises an aqueous solution of CsOH and KOH, each in a concentration of from about 0.5 M to about 6 M with a combined total concentration of from about 1 M to about 8 M, from about 2 M to about 7 M or from about 2 M to about 6 M.
E28. A battery according to embodiment 27 where the molar ratio of CsOH to KOH is from about 5:1 to about 1:3.
E29. A battery according to embodiment 20 where the electrolyte composition comprises an aqueous solution of RbOH and KOH, where RbOH is in a concentration of from about 2 M to about 6 M and KOH is in a concentration of from about 0.5 M to about 3 M with a combined total concentration of from about 2.5 M to about 8 M.
E30. A battery according to embodiment 29 where the molar ratio of RbOH to KOH is from about 5:1 to about 3:2.
E31. A battery according to embodiment 20 where the electrolyte composition comprises an aqueous solution of an ammonium hydroxide compound and KOH, where the ammonium hydroxide is in a concentration of from about 0.3 M to about 3 M and KOH is in a concentration of from about 1 M to about 6 M with a combined total concentration of from about 1.3 M to about 8 M.
E32. A battery according to embodiment 31 where the molar ratio of the ammonium hydroxide to KOH is from about 1:2 to about 1:8.
E33. A battery according to any of the preceding embodiments where the degradation of the anode material in the battery is ≦90%, ≦85%, ≦80%, ≦75% or ≦70% of the degradation of the same anode material in the same battery when replacing the electrolyte composition with 6 M aqueous KOH.
E34. A battery according to any of the preceding embodiments where the conductivity of the electrolyte composition is ≧55%, ≧60%, ≧65%≧70% or ≧75% of that of 6 M aqueous KOH.
E35. A metal hydride battery comprising at least one negative electrode comprising an active anode material, at least one positive electrode comprising an active cathode material, a casing having said electrodes positioned therein and an electrolyte composition, where

the electrolyte composition comprises an aqueous solution comprising one or more compounds selected from the group consisting of metal hydroxides, metal oxide/hydroxides and ammonium hydroxides,

the degradation of the anode material in the battery is ≦95% of the degradation of the same anode material in the same battery when replacing the electrolyte composition with 6 M aqueous KOH,

the conductivity of the electrolyte composition is ≧50% of 6 M aqueous KOH and where

when the electrolyte composition comprises KOH, the composition also comprises one or more further compounds selected from the group consisting of metal hydroxides, metal oxide/hydroxides and ammonium hydroxides.

E36. A battery according to embodiment 35 where the anode material comprises an ABx hydrogen storage alloy where x is from about 0.5 to about 5 and which has a discharge capacity of ≧400 mAh/g, ≧425 mAh/g, ≧450 mAh/g or ≧475 mAh/g.
E37. A battery according to embodiments 35 or 36 where the anode material comprises Mg.
E38. A battery according to any of embodiments 35 to 37 where the anode material comprises Mg and Ni in an atomic ratio of from about 1:2 to about 2:1.
E39. A battery according to embodiment 38 where the anode material further comprises one or more modifying elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca.
E40. A battery according to embodiment 39 where the one or more modifying elements are present from about 0.1 to about 30 at % or from about 0.25 to about 15 at % or from about 0.5, about 1, about 2, about 3, about 4 or about 5 at % to about 15 at %, based on the total alloy.
E41. A battery according to any of embodiments 38 to 40 where the atomic ratio of Mg to Ni is about 1:1.
E42. A battery according to any of embodiments 35 to 40 where the anode material is Mg₅₂Ni₃₉Co₆Mn₃ or Mg₅₂Ni₃₉Co₃Mn₆.
E43. A battery according to any of embodiments 35 to 42 where the electrolyte composition comprises one or more ammonium hydroxide compounds.
E44. A battery according to any of embodiments 35 to 43 where the electrolyte composition comprises one or more metal hydroxides.
E45. A battery according to any of embodiments 35 to 44 where the electrolyte composition comprises one or more metal oxide/hydroxides.
E46. A battery according to any of the embodiments 35 to 45 where the electrolyte composition comprises one or more transition metal hydroxides.
E47. A battery according to any of embodiments 35 to 46 where the electrolyte composition comprises one or more rare earth metal hydroxides.
E48. A battery according to any of embodiments 35 to 47 where the electrolyte composition comprises one or more alkali metal hydroxides.
E49. A battery according to any of embodiments 35 to 48 where the electrolyte composition comprises one or more alkali earth metal hydroxides.
E50. A battery according to any of embodiments 35 to 49 where the electrolyte composition comprises one or more post-transition metal hydroxides.
E51. A battery according to any of embodiments 35 to 50 where the electrolyte composition comprises one or more metalloid metal hydroxides.
E52. A battery according to any of embodiments 35 to 51 where the electrolyte composition comprises one or more compounds selected from the group consisting of LiOH, NaOH, KOH, RbOH, CsOH, Be(OH)₂, Mg(OH)₂, Ca(OH)₂, Sr(OH)₂, Ba(OH)₂ and ammonium hydroxide compounds.
E53. A battery according to any of embodiments 35 to 52 where the electrolyte composition comprises one or more compounds selected from the group consisting of NaOH, RbOH, CsOH and ammonium hydroxide compounds.
E54. A battery according to any of embodiments 35 to 53 where the electrolyte composition comprises one or more ammonium hydroxide compounds containing an ammonium cation selected from the group consisting of NH₄⁺ (ammonium), methylammonium, ethylammonium, dimethylammonium, diethylammonium, trimethylammonium (NMe₃H⁺), triethylammonium, tributylammonium, diethylmethylammonium, hydroxyethylammonium, methoxymethylammonium, dibutylammonium, methylbutylammonium, anilinium, pyridinium, 2-methylpyridinium, imidazolium, 1-methylimidazolium, 1,2-dimethylimidazolium, imidazolinium, 1-ethylimidazolium, 1-(4-sulfobutyl)-3-methylimidazolium, 1-allylimidazolium, ethanolammonium, quinolinium, isoquinolinium, pyrrolinium, pyrrolininium, pyrrolidinium, tetramethylammonium, tetraethylammonium, tetra-n-butylammonium, n-butyl-tri-ethylammonium, benzyl-tri-methylammonium, tri-n-butylmethylammonium, benzyl-tri-ethylammonium, 1-methylpyridinium, 1-butyl-3,5-dimethylpyridinium, 1,2,4-trimethylpyrazolium, trimethylhydroxyethylammonium (choline), tri-(hydroxyethyl)methylammonium, dimethyl-di(polyoxyethylene)ammonium, 1,2,3-trimethylimidazolium, 1-butyl-3-methylimidazolium, 1-ethyl-2,3-dimethylimidazolium, 1-allyl-3-methylimidazolium, 1-hydroxyethyl-3-methylimidazolium, 1,3-dimethylimidazolium, 1-ethyl-1-methylpiperidinium, 4-ethyl-4-methylmorpholinium, 1-(cyanomethyl)-3-methylimidazolium, 1-(3-cyanopropyl)pyridinium, 1,3-bis(cyanomethyl)imidazolium and 1-ethyl-3-methylimidazolium.
E55. A battery according to any of embodiments 35 to 54 comprising at least two different compounds selected from the group consisting of metal hydroxides, metal oxide/hydroxides and ammonium hydroxides.
E56. A battery according to any of embodiments 35 to 55 where the electrolyte composition comprises aqueous NaOH in a concentration of from about 3 M to about 7 M, or about 4 M, about 5 M or about 6 M.
E57. A battery according to any of embodiments 35 to 56 where the electrolyte composition comprises aqueous CsOH in a concentration of from about 2 M to about 6 M, or about 3 M, about 4 M or about 5 M.
E58. A battery according to any of embodiments 35 to 57 where the electrolyte composition comprises aqueous RbOH in a concentration of from about 2 M to about 6 M, or about 3 M, about 4 M or about 5 M.
E59. A battery according to any of embodiments 35 to 58 where the electrolyte composition comprises one or more aqueous ammonium hydroxide compounds in a total concentration of from about 0.3 M to about 5 M, or about 0.6 M, about 1 M, about 2 M, about 3 M or about 4 M.
E60. A battery according to embodiment 55 where electrolyte composition comprises an aqueous solution of NaOH and KOH, each in a concentration of from about 0.5 M to about 6 M with a total combined concentration of from about 1 M to about 8 M, from about 2 M to about 7 M or from about 3 M to about 6 M.
E61. A battery according to embodiment 60 where the molar ratio of NaOH to KOH is from about 5:1 to about 1:11.
E62. A battery according to embodiment 55 where the electrolyte composition comprises an aqueous solution of CsOH and KOH, each in a concentration of from about 0.5 M to about 6 M with a combined total concentration of from about 1 M to about 8 M, from about 2 M to about 7 M or from about 2 M to about 6 M.
E63. A battery according to embodiment 62 where the molar ratio of CsOH to KOH is from about 5:1 to about 1:3.
E64. A battery according to embodiment 55 where the electrolyte composition comprises an aqueous solution of RbOH and KOH, where RbOH is in a concentration of from about 2 M to about 6 M and KOH is in a concentration of from about 0.5 M to about 3 M with a combined total concentration of from about 2.5 M to about 8 M.
E65. A battery according to embodiment 64 where the molar ratio of RbOH to KOH is from about 5:1 to about 3:2.
E66. A battery according to embodiment 55 where the electrolyte composition comprises an aqueous solution of an ammonium hydroxide compound and KOH, where the ammonium hydroxide is in a concentration of from about 0.3 M to about 3 M and KOH is in a concentration of from about 1 M to about 6 M with a combined total concentration of from about 1.3 M to about 8 M.
E67. A battery according to embodiment 66 where the molar ratio of the ammonium hydroxide to KOH is from about 1:2 to about 1:8.
E68. A battery according to any of embodiments 35 to 67 where the degradation of the anode material in the battery is ≦90%, ≦85%, ≦80%, ≦75% or ≦70% of the degradation of the same anode material in the same battery when replacing the electrolyte composition with 6 M aqueous KOH.
E69. A battery according to any of embodiments 35 to 68 where the conductivity of the electrolyte composition is ≧55%, ≧60%, ≧65%≧70% or ≧75% of that of 6 M aqueous KOH.

### EXAMPLES

About 70 mg of Mg₅₂Ni₃₉Co₆Mn₃ metal hydride alloy powder prepared by melt-spin and mechanical alloying is compacted onto an expanded nickel substrate with a 10-ton press to form the negative working electrode, approximately 0.2 mm in thickness, without any binder. An aqueous solution one or more hydroxide compounds is prepared as the electrolyte. Two halves of sintered Ni(OH)₂ positive electrode, each 1 cm² in area and 1.5 mm in thickness, are connected by a nickel tab strip and used as the counter electrode.

A piece of grafted polypropylene/polyethylene separator is folded in half twice and sandwiches the negative electrode so that there are two layers of separator on each side thereof. Next, two halves of positive electrode sandwiches the wrapped negative electrode. The electrode assembly is placed into a plastic sleeve, which is then slid into an acrylic cell holder. The sleeve is filled with electrolyte using a pipette. After absorbing for five minutes, the sleeve is filled again with electrolyte so that it is in a flooded cell configuration.

The cell is charged at a current density of 100 mA/g for 5 hours and discharged at a current density of 100 mA/g until a cut-off voltage of 0.9 V is reached, discharged at a current density of 24 mA/g until a cut-off voltage of 0.9 V is reached and finally discharged at a current density of 8 mA/g until a cut-off voltage of 0.9 V is reached. The full discharge capacity is the sum of capacities measured at 100, 24 and 8 mA/g for each cycle.

Degradation is determined over 10 cycles. The percent capacity loss per cycle is determined as outlined previously.

Results are in the table below. The table lists electrolyte compositions with hydroxide compound values in mols/L (M) water. Degradation and conductivity are reported in percent relative to 6 M aqueous KOH electrolyte. Low degradation and high conductivity are desired. TeaOH is tetraethylammonium hydroxide. Conductivity is measured with a YSI model 3200 conductivity meter. Capacity is measured with an Arbin Instruments Battery Test System.

| NaOH | RbOH | CsOH | TeaOH | KOH | degradation | conductivity |
|---|---|---|---|---|---|---|
| — | — | — | — | 6 | 100 | 100 |
| 6 | — | — | — | — | 67.4 | 58.5 |
| 5 | — | — | — | — | 65.9 | 63.3 |
| 4 | — | — | — | — | 75.9 | 65.2 |
| 5 | — | — | — | 1 | 64.6 | 64.4 |
| 4 | — | — | — | 1 | 65.8 | 70.0 |
| 3 | — | — | — | 1 | 78.9 | 72.2 |
| 1 | — | — | — | 1 | 89.1 | 57.5 |
| 4 | — | — | — | 2 | 89.5 | 71.3 |
| 3 | — | — | — | 2 | 89.9 | 75.9 |
| 1 | — | — | — | 2 | 91.9 | 72.1 |
| 1 | — | — | — | 3 | 89.9 | 82.9 |
| 1 | — | — | — | 5 | 92.7 | 92.3 |
| 0.5 | — | — | — | 5.5 | 94.4 | 95.2 |
| — | 4 | — | — | — | 86.4 | 51.1 |
| — | 3 | — | — | — | 92.4 | 66.2 |
| — | 5 | — | — | 1 | 88.7 | 68.5 |
| — | 4 | — | — | 1 | 87.0 | 61.5 |
| — | 4 | — | — | 2 | 92.5 | 70.8 |
| — | 3 | — | — | 1 | 84.3 | 53.4 |
| — | 3 | — | — | 2 | 95.0 | 88.7 |
| — | — | 5 | — | — | 90.8 | 53.4 |
| — | — | 4 | — | — | 77.6 | 78.1 |
| — | — | 3 | — | — | 85.3 | 78.6 |
| — | — | 5 | — | 1 | 92.8 | 71.3 |
| — | — | 4 | — | 1 | 94.9 | 61.6 |
| — | — | 3 | — | 1 | 82.3 | 50.6 |
| — | — | 1 | — | 1 | 76.4 | 59.8 |
| — | — | 4 | — | 2 | 93.6 | 71.3 |
| — | — | 3 | — | 2 | 86.3 | 60.3 |
| — | — | 1 | — | 2 | 88.8 | 79.9 |
| — | — | 3 | — | 3 | 86.2 | 69.3 |
| — | — | 1 | — | 3 | 89.4 | 89.0 |
| — | — | — | 1.24 | 3 | 78.3 | 56.3 |
| — | — | — | 1.24 | 4 | 84.4 | 73.5 |
| — | — | — | 0.62 | 2 | 76.6 | 52.9 |
| — | — | — | 0.62 | 3 | 81.9 | 61.8 |
| — | — | — | 0.62 | 4 | 83.1 | 69.2 |
| — | — | — | 0.62 | 5 | 93.8 | 75.7 |

1. A metal hydride battery comprising at least one negative electrode comprising an active anode material, at least one positive electrode comprising an active cathode material, a casing having said electrodes positioned therein and an electrolyte composition, where
the anode material comprises an ABx hydrogen storage alloy comprising Mg where x is from about 0.5 to about 5,
the electrolyte composition comprises an aqueous solution comprising one or more compounds selected from the group consisting of metal hydroxides, metal oxide/hydroxides and ammonium hydroxides and
when the electrolyte composition comprises KOH, the composition also comprises one or more further compounds selected from the group consisting of metal hydroxides, metal oxide/hydroxides and ammonium hydroxides.

2. A battery according to claim 1 where the anode material comprises Mg and Ni in an atomic ratio of from about 1:2 to about 2:1 and has a discharge capacity of ≧400 mAh/g.

3. A battery according to claim 2 where the anode material further comprises from about 0.1 to about 30 at % of one or more modifying elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca.

4. A battery according to claim 1 where the atomic ratio of Mg to Ni is about 1:1.

5. A battery according to claim 1 where the anode material is Mg₅₂Ni₃₉Co₆Mn₃ or Mg₅₂Ni₃₉Co₃Mn₆.

6. A battery according to claim 1 where the electrolyte composition comprises one or more compounds selected from the group consisting of alkali metal, alkali earth metal and ammonium hydroxide compounds.

7. A battery according to claim 1 where the electrolyte composition comprises one or more compounds selected from the group consisting of LiOH, NaOH, KOH, RbOH, CsOH, Be(OH)₂, Mg(OH)₂, Ca(OH)₂, Sr(OH)₂, Ba(OH)₂ and ammonium hydroxide compounds.

8. A battery according to claim 1 where the electrolyte composition comprises one or more ammonium hydroxide compounds.

9. A battery according to claim 1 where the electrolyte composition comprises one or more ammonium hydroxide compounds containing an ammonium cation selected from the group consisting of NH₄⁺, methylammonium, ethylammonium, dimethylammonium, diethylammonium, trimethylammonium, triethylammonium, tributylammonium, diethylmethylammonium, hydroxyethylammonium, methoxymethylammonium, dibutylammonium, methylbutylammonium, anilinium, pyridinium, 2-methylpyridinium, imidazolium, 1-methylimidazolium, 1,2-dimethylimidazolium, imidazolinium, 1-ethylimidazolium, 1-(4-sulfobutyl)-3-methylimidazolium, 1-allylimidazolium, ethanolammonium, quinolinium, isoquinolinium, pyrrolinium, pyrrolininium, pyrrolidinium, tetramethylammonium, tetraethylammonium, tetra-n-butylammonium, n-butyl-tri-ethylammonium, benzyl-tri-methylammonium, tri-n-butylmethylammonium, benzyl-tri-ethylammonium, 1-methylpyridinium, 1-butyl-3,5-dimethylpyridinium, 1,2,4-trimethylpyrazolium, trimethylhydroxyethylammonium, tri-(hydroxyethyl)methylammonium, dimethyl-di(polyoxyethylene)ammonium, 1,2,3-trimethylimidazolium, 1-butyl-3-methylimidazolium, 1-ethyl-2,3-dimethylimidazolium, 1-allyl-3-methylimidazolium, 1-hydroxyethyl-3-methylimidazolium, 1,3-dimethylimidazolium, 1-ethyl-1-methylpiperidinium, 4-ethyl-4-methylmorpholinium, 1-(cyanomethyl)-3-methylimidazolium, 1-(3-cyanopropyl)pyridinium, 1,3-bis(cyanomethyl)imidazolium and 1-ethyl-3-methylimidazolium.

10. A battery according to claim 1 comprising at least two different compounds selected from the group consisting of metal hydroxides, metal oxide/hydroxides and ammonium hydroxides.

11. A battery according to claim 1 where the electrolyte composition comprises aqueous NaOH in a concentration of from about 3 M to about 7 M, aqueous CsOH in a concentration of from about 2 M to about 6 M, aqueous RbOH in a concentration of from about 2 M to about 6 M or one or more aqueous ammonium hydroxide compounds in a concentration of from about 0.3 M to about 5 M.

12. A battery according to claim 10 where electrolyte composition comprises an aqueous solution of NaOH and KOH, each in a concentration of from about 0.5 M to about 6 M with a total combined concentration of from about 1 M to about 8 M and where the molar ratio of NaOH to KOH is from about 5:1 to about 1:11.

13. A battery according to claim 10 where the electrolyte composition comprises an aqueous solution of CsOH and KOH, each in a concentration of from about 0.5 M to about 6 M with a combined total concentration of from about 1 M to about 8 M and where the molar ratio of CsOH to KOH is from about 5:1 to about 1:3.

14. A battery according to claim 10 where the electrolyte composition comprises an aqueous solution of RbOH and KOH, where RbOH is in a concentration of from about 2 M to about 6 M and KOH is in a concentration of from about 0.5 M to about 3 M with a combined total concentration of from about 2.5 M to about 8 M and where the molar ratio of RbOH to KOH is from about 5:1 to about 3:2.

15. A battery according to claim 10 where the electrolyte composition comprises an aqueous solution of an ammonium hydroxide compound and KOH, where the ammonium hydroxide is in a concentration of from about 0.3 M to about 3 M and KOH is in a concentration of from about 1 M to about 6 M with a combined total concentration of from about 1.3 M to about 8 M and where the molar ratio of the ammonium hydroxide to KOH is from about 1:2 to about 1:8.

16. A battery according to claim 1 where the degradation of the anode material in the battery is ≦90% of the degradation of the same anode material in the same battery when replacing the electrolyte composition with 6 M aqueous KOH and where the conductivity of the electrolyte composition is ≧55% of that of 6 M aqueous KOH.

17. A metal hydride battery comprising at least one negative electrode comprising an active anode material, at least one positive electrode comprising an active cathode material, a casing having said electrodes positioned therein and an electrolyte composition, where
the electrolyte composition comprises an aqueous solution comprising one or more compounds selected from the group consisting of metal hydroxides, metal oxide/hydroxides and ammonium hydroxides compounds,
the degradation of the anode material in the battery is ≦95% of the degradation of the same anode material in the same battery when replacing the electrolyte composition with 6 M aqueous KOH,
the conductivity of the electrolyte composition is ≧50% of 6 M aqueous KOH and where
when the electrolyte composition comprises KOH, the composition also comprises one or more further compounds selected from the group consisting of metal hydroxides, metal oxide/hydroxides and ammonium hydroxides.

18. A battery according to claim 17 where the anode material comprises Mg.

19. A battery according to claim 17 where the anode material comprises Mg and Ni in an atomic ratio of from about 1:2 to about 2:1 and has a discharge capacity of ≧400 mAh/g.

20. A battery according to claim 19 where the anode material further comprises from about 0.1 to about 30 at % of one or more modifying elements selected from the group consisting of Co, Mn, Al, Fe, Cu, Mo, W, Cr, V, Ti, Zr, Sn, Th, Si, Zn, Li, Cd, Na, Pb, La, Ce, Pr, Nd, Mm, Pd, Pt, Nb, Sc and Ca.

21. A battery according to claim 17 where the atomic ratio of Mg to Ni is about 1:1.

22. A battery according to claim 17 where the anode material is Mg₅₂Ni₃₉Co₆Mn₃ or Mg₅₂Ni₃₉Co₃Mn₆.

23. A battery according to claim 17 where the electrolyte composition comprises one or more compounds selected from the group consisting of alkali metal hydroxide, alkali earth metal hydroxide and ammonium hydroxide compounds.

24. A battery according to claim 17 where the electrolyte composition comprises one or more compounds selected from the group consisting of LiOH, NaOH, KOH, RbOH, CsOH, Be(OH)₂, Mg(OH)₂, Ca(OH)₂, Sr(OH)₂, Ba(OH)₂ and ammonium hydroxide compounds.

25. A battery according to claim 17 where the electrolyte composition comprises one or more ammonium hydroxide compounds.

26. A battery according to claim 17 where the electrolyte composition comprises one or more ammonium hydroxide compounds containing an ammonium cation selected from the group consisting of NH₄⁺, methylammonium, ethylammonium, dimethylammonium, diethylammonium, trimethylammonium, triethylammonium, tributylammonium, diethylmethylammonium, hydroxyethylammonium, methoxymethylammonium, dibutylammonium, methylbutylammonium, anilinium, pyridinium, 2-methylpyridinium, imidazolium, 1-methylimidazolium, 1,2-dimethylimidazolium, imidazolinium, 1-ethylimidazolium, 1-(4-sulfobutyl)-3-methylimidazolium, 1-allylimidazolium, ethanolammonium, quinolinium, isoquinolinium, pyrrolinium, pyrrolininium, pyrrolidinium, tetramethylammonium, tetraethylammonium, tetra-n-butylammonium, n-butyl-tri-ethylammonium, benzyl-tri-methylammonium, tri-n-butylmethylammonium, benzyl-tri-ethylammonium, 1-methylpyridinium, 1-butyl-3,5-dimethylpyridinium, 1,2,4-trimethylpyrazolium, trimethylhydroxyethylammonium, tri-(hydroxyethyl)methylammonium, dimethyl-di(polyoxyethylene)ammonium, 1,2,3-trimethylimidazolium, 1-butyl-3-methylimidazolium, 1-ethyl-2,3-dimethylimidazolium, 1-allyl-3-methylimidazolium, 1-hydroxyethyl-3-methylimidazolium, 1,3-dimethylimidazolium, 1-ethyl-1-methylpiperidinium, 4-ethyl-4-methylmorpholinium, 1-(cyanomethyl)-3-methylimidazolium, 1-(3-cyanopropyl)pyridinium, 1,3-bis(cyanomethyl)imidazolium and 1-ethyl-3-methylimidazolium.

27. A battery according to claim 17 comprising at least two different compounds selected from the group consisting of metal hydroxides, metal oxide/hydroxides and ammonium hydroxides.

28. A battery according to claim 17 where the electrolyte composition comprises aqueous NaOH in a concentration of from about 3 M to about 7 M, aqueous CsOH in a concentration of from about 2 M to about 6 M, aqueous RbOH in a concentration of from about 2 M to about 6 M or one or more aqueous ammonium hydroxide compounds in a concentration of from about 0.3 M to about 5 M.

29. A battery according to claim 27 where electrolyte composition comprises an aqueous solution of NaOH and KOH, each in a concentration of from about 0.5 M to about 6 M with a total combined concentration of from about 1 M to about 8 M and where the molar ratio of NaOH to KOH is from about 5:1 to about 1:11.

30. A battery according to claim 27 where the electrolyte composition comprises an aqueous solution of CsOH and KOH, each in a concentration of from about 0.5 M to about 6 M with a combined total concentration of from about 1 M to about 8 M and where the molar ratio of CsOH to KOH is from about 5:1 to about 1:3.

31. A battery according to claim 27 where the electrolyte composition comprises an aqueous solution of RbOH and KOH, where RbOH is in a concentration of from about 2 M to about 6 M and KOH is in a concentration of from about 0.5 M to about 3 M with a combined total concentration of from about 2.5 M to about 8 M and where the molar ratio of RbOH to KOH is from about 5:1 to about 3:2.

32. A battery according to claim 27 where the electrolyte composition comprises an aqueous solution of an ammonium hydroxide compound and KOH, where the ammonium hydroxide is in a concentration of from about 0.3 M to about 3 M and KOH is in a concentration of from about 1 M to about 6 M with a combined total concentration of from about 1.3 M to about 8 M and where the molar ratio of the ammonium hydroxide to KOH is from about 1:2 to about 1:8.

33. A battery according to claim 17 where the degradation of the anode material in the battery is ≦90% of the degradation of the same anode material in the same battery when replacing the electrolyte composition with 6 M aqueous KOH and where the conductivity of the electrolyte composition is ≧55% of that of 6 M aqueous KOH.
